(19) United States
(12) Patent Application Publication
(10) Pub. No.: US 2024/0301239 A1
(43) Pub. Date: Sep. 12, 2024

(54) MULTILAYER SURFACING FILMS

(71) Applicant: 3M INNOVATIVE PROPERTIES COMPANY, St. Paul, MN (US)

(72) Inventors: Yongshang Lu, Woodbury, MN (US); Charlie Chia-Tie Ho, Woodbury, MN (US); Timothy J. Brookshaw, Prescott, WI (US); Jay M. Jennen, Forest Lake, MN (US); Todd G. Pett, St. Paul, MN (US); Tong Wei, Woodbury, MN (US); David P. Siglin, St. Paul, MN (US)

(21) Appl. No.: 18/289,265

(22) PCT Filed: May 9, 2022
(86) PCT No.: PCT/IB2022/054280

§ 371 Date: Nov. 2, 2023

Related U.S. Application Data
(60) Provisional application No. 63/186,326, filed on May 10, 2021.

(51) Int. Cl. C09D 175/14; C08G 18/62

(52) U.S. Cl. CPC C09D 175/14; C08G 18/6225; C08G 2150/00

(57) ABSTRACT

Provided is a surfacing film that includes a plurality of layers. The layers include a first clear coat layer made from a crosslinked polyurethane that is a reaction product of a reactive mixture including an isocyanate and a polyol containing a styrene repeat unit and a hydroxyl-containing (meth)acrylate repeat unit. The surfacing film further includes a bulk layer made from a thermoplastic polyurethane and an adhesive layer. Optionally, the surfacing film includes second clear coat layer, which can be made from a polyurethane that is at least partially crosslinked. The resulting surfacing film can display high stain resistance, high peel strength, superior scratch resistance and self-healing properties.

### FIELD OF THE INVENTION

Provided are surfacing films for paint protection or paint replacement applications. The provided films can be useful, for example, in paint protection or paint replacement applications for automotive and aerospace exteriors.

### BACKGROUND

Surfacing films are applied to exterior surfaces and protect underlying substrates from damage caused by environmental weathering, chemical exposure, heat, and/or abrasion. These films can be used to protect either painted or unpainted surfaces. When applied to a painted surface, they are commonly referred to as paint protection films. When applied to unpainted surfaces, they can be used to provide color, in which case they may be referred to as body color film or paint replacement film.

Films made from polyurethane can withstand harsh environments, making them suitable for these applications. Polyurethanes are synthetic polymers of great commercial and industrial importance. They are commonly prepared by reacting a multifunctional isocyanate with a multifunctional diol or polyol in the presence of a catalyst to produce polymers containing carbamate (—NH—CO—O—) linkages. Thermoplastic polyurethanes are characterized by linear polymeric chains having self-ordering block structures, while thermoset polyurethanes are highly crosslinked by covalent bonds.

Depending on the components used to make the polyurethane, these materials can be engineered to display a high degree of chemical resistance and a wide range of material properties. Polyurethanes can also be extremely durable and flexible, making them desirable materials for many applications. Other useful commercial and industrial applications include high-resilience foam seating, rigid foam insulation panels, microcellular foam seals and gaskets, hoses, elastomeric wheels and tires, automotive suspension bushings, electrical potting compounds, high performance adhesives, coatings and sealants, synthetic fibers, and carpet underlayment.

### SUMMARY

Conventional surfacing films display varying degrees of scratch resistance, self-healing properties, and stain resistance, with significant margin for improvement. For example, there is a continued potential to improve both initial and aged adhesive peel strength. Further, these products can have a strong odor as a result of residual solvent and/or other volatile compounds in the adhesive, which can provide an undesirable user experience. The scratch resistance and self-healing properties of these conventional films can also be limited by their composition and crosslink density.

The provided processes and articles uses a copolymerized acrylic-styrene polyol containing a multiplicity of hydroxyl groups. This enables crosslink density to be dramatically increased relative to those of prior film compositions. Moreover, it is possible to use dual-layered clear coat layer constructions to mitigate or eliminate the odor issues above.

In an exemplary process, the surfacing film can be produced by coating a first layer of a crosslinkable reactive polyurethane clear coat on a releasable polyester carrier web which is cured to produce a first clear coat layer, then coating a second crosslinkable polyurethane clear coat layer over the first layer clear coat which is at least partially cured to provide a primer layer. One or more thermoplastic polyurethane layers can then be laminated to the exposed surface of the second clear coat layer of crosslinkable polyurethane layer by an extrusion process or by a hot lamination process. The remaining side of the thermoplastic polyurethane layer can then be laminated to a transfer adhesive.

The resulting surfacing film displays a surprisingly high stain resistance and high initial adhesive peel strength as well as aged peel strength. The provided surfacing film can also show superior scratch resistance and self-healing properties. Further, when the above clear coat composition is incorporated in dual-layer constructions, it is also possible to substantially avoid solvent odor attributable to the adhesive. The process of producing the multilayer paint film also allows for significantly improved throughput yield and reduced factory costs.

In a first aspect, a surfacing film is provided. The surfacing film comprises a plurality of layers, in the following order: a first clear coat layer comprising a crosslinked polyurethane that is a reaction product of a reactive mixture comprising an isocyanate and a polyol containing a styrene repeat unit and a hydroxyl-containing (meth)acrylate repeat unit; and a bulk layer comprising a thermoplastic polyurethane; and an adhesive layer.

In a second aspect, a process of making a surfacing film is provided, comprising: disposing a first curable polyurethane clear coat composition on a first release liner, the first curable polyurethane clear coat composition comprising a copolymer of styrene and hydroxyl-containing (meth)acrylate; only partially curing the first curable polyurethane clear coat composition to provide a first clear coat layer; disposing a second curable polyurethane clear coat composition onto the first clear coat layer; at least partially curing the second curable polyurethane clear coat composition to provide a second clear coat layer on the first clear coat layer; disposing a thermoplastic polyurethane layer onto the second clear coat layer; and disposing an adhesive layer onto the thermoplastic polyurethane layer.

### BRIEF DESCRIPTION OF THE DRAWINGS

FIGS. 1 and 2 are a side, cross-sectional view of surfacing films according to two exemplary embodiments; and

FIG. 3 is a block diagram showing an exemplary process for making a surfacing film.

Repeated use of reference characters in the specification and drawings is intended to represent the same or analogous features or elements of the disclosure. It should be understood that numerous other modifications and embodiments can be devised by those skilled in the art, which fall within the scope and spirit of the principles of the disclosure. The figures may not be drawn to scale.

### Definitions

As used herein:
“ambient conditions” means at a temperature of 21 degrees Celsius and a pressure of 1 atmosphere (approximately 100 kilopascals);
“catalyst” means a substance that can increase the speed of a chemical reaction;
“diol” means a compound having a hydroxyl functionality of exactly two;
“diisocyanate” means a compound having an isocyanate functionality of exactly two;
“cure” means to alter the physical state and or chemical state of the composition to make it transform from a fluid to less fluid state, to go from a tacky to a non-tacky state, to go from a soluble to insoluble state, to decrease the amount of polymerizable material by its consumption in a chemical reaction, or go from a material with a specific molecular weight to a higher molecular weight;
“curable” means capable of being cured;
“fully cured” means cured to a state where the composition is suitable for use in its intended application, such as a percent conversion as determined by Fourier Transform Infrared Spectroscopy (FTIR) using the method described in Chai, C, Hou, J, Yang, X, Ge, Z, Huang, M & Li, G 2018, ‘Two-component waterborne polyurethane: Curing process study using dynamic in situ IR spectroscopy’, Polymer Testing, vol. 69, pp. 259-265;
“partially cured” means cured to a state that is less than fully cured;
“polyisocyanate” means a compound having an isocyanate functionality of two or more;
“polyol” means a compound having a hydroxyl functionality of two or more; and
“primary isocyanate” means a carbon atom upon which the isocyanate group is attached also has two hydrogen atoms.
“weight average molecular weight” refers to the weight average molecular weight by gel permeation chromatography (i.e., size exclusion chromatography) using techniques known to one of skill in the art.

### DETAILED DESCRIPTION

As used herein, the terms “preferred” and “preferably” refer to embodiments described herein that may afford certain benefits under certain circumstances. However, other embodiments may also be preferred, under the same or other circumstances. Furthermore, the recitation of one or more preferred embodiments does not imply that other embodiments are not useful, and other embodiments are not excluded from the scope of the invention.

As used herein and in the appended claims, the singular forms “a,” “an,” and “the” include plural referents unless the context clearly dictates otherwise. Thus, for example, reference to “a” or “the” component may include one or more of the components and equivalents thereof known to those skilled in the art. Further, the term “and/or” means one or all of the listed elements or a combination of any two or more of the listed elements.

It is noted that the term “comprises” and variations thereof do not have a limiting meaning where these terms appear in the accompanying description. Moreover, “a,” “an,” “the,” “at least one,” and “one or more” are used interchangeably herein.

Relative terms such as left, right, forward, rearward, top, bottom, side, upper, lower, horizontal, vertical, and the like may be used herein and, if so, are from the perspective observed in the particular figure. These terms are used only to simplify the description, however, and not to limit the scope of the invention in any way. Figures are not necessarily to scale.

Reference throughout this specification to “one embodiment,” “certain embodiments,” “one or more embodiments” or “an embodiment” means that a particular feature, structure, material, or characteristic described in connection with the embodiment is included in at least one embodiment of the invention. Thus, the appearances of the phrases such as “in one or more embodiments,” “in certain embodiments,” “in one embodiment” or “in an embodiment” in various places throughout this specification are not necessarily referring to the same embodiment of the invention. Furthermore, the particular features, 15 structures, materials, or characteristics may be combined in any suitable manner in one or more embodiments.

### Layer Constructions

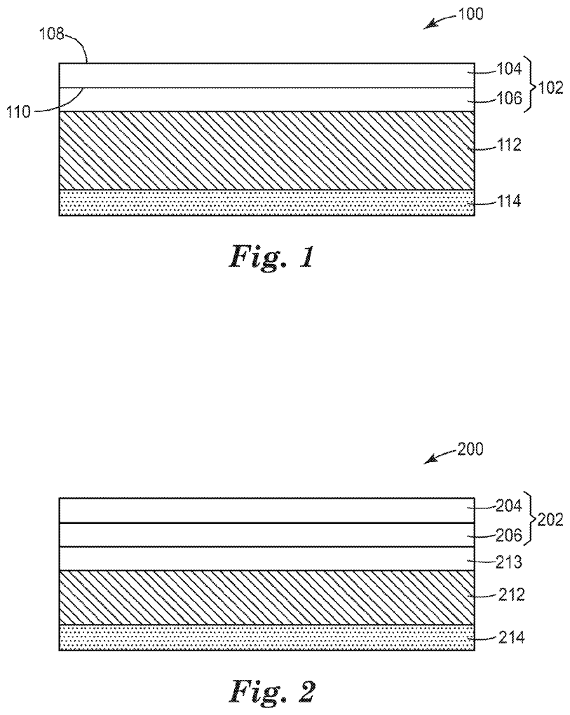

A multilayered surfacing film according to one embodiment is illustrated in FIG. 1 and herein designated by the numeral 100. As shown, the surfacing film 100 includes a composite clear coat layer 102 that includes a first clear coat layer 104 and a second clear coat layer 106.

As shown, the first clear coat layer 104 has a top surface 108 and bottom surface 110. The top surface 108 is optionally an exposed major surface of the surfacing film 100 as shown, but can optionally be covered by a protective liner or cover layer so as to avoid scratching the surfacing film 100 during storage and handling.

The first clear coat layer 104 is a reaction product obtained by curing a reactive mixture. The reactive mixture includes monomeric compounds that react with each other to provide a cured, hardened layer. Preferred reactive mixtures used to obtain the first clear coat layer 104 are reactive urethane compositions including an isocyanate and a polyol containing a styrene repeat unit and a hydroxyl-containing (meth)acrylate repeat unit. In a preferred embodiment, the polyol is a copolymer that includes at least a styrene repeat unit and a hydroxyl-containing (meth)acrylate repeat unit. This copolymer may be a random copolymer, block copolymer, or combination thereof (e.g., a tapered block copolymer).

Useful copolymers are represented by Structure I below, which shows a copolymer of hydroxyalkylacrylate, styrene, and alkyl (meth)acrylate:

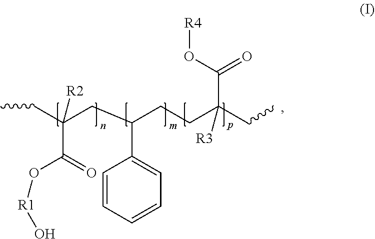

where R1 is a divalent alkylene group having 1 to 12 carbon atoms, R2 and R3 are independently either a hydrogen atom or CH₃ group, and R4 is an alkyl group having 1 to 8 carbon atoms.

In some embodiments, the hydroxyl-containing (meth)acrylate is a hydroxyalkyl (meth)acrylate. The hydroxyalkyl (meth)acrylate used in the polyol need not be particularly limited, and can include for example hydroxymethyl (meth)acrylate, 2-hydroxyethyl (meth)acrylate, 2-hydroxypropyl (meth)acrylate, 4-hydroxybutyl (meth)acrylate, 5-hydroxypentyl (meth)acrylate, 2-hydroxyoctyl (meth)acrylate, 12-hydroxydodecyl (meth)acrylate, or a combination thereof.

It can be a significant technical advantage for the polyol, such as the polyol of Structure I above, to have a functionality significantly greater than 2 to enhance hardness of the first clear coat layer 104. The functionality of the polyol can be from 2 to 50, 5 to 50, 10 to 50, or in some embodiments, less than, equal to, or greater than 2, 3, 4, 5, 7, 10, 12, 15, 20, 25, 30, 35, 40, 45, or 50. The polyol can have a weight average molecular weight of from 250 g/mol to 30000 g/mol, from 275 g/mol to 20000 g/mol, from 300 g/mol to 10000 g/mol, or in some embodiments, less than, equal to, or greater than 250 g/mol, 275, 300, 350, 400, 450, 500, 600, 700, 800, 900, 1000, 2000, 5000, 7000, 10000, 15000, 20000, 25000, or 30000 g/mol.

The third monomer in Structure I above need not be present but incorporating the repeat unit of a relatively high-T_{g} monomer such as methyl methacrylate can be beneficial in increasing the T_{g} of the coating and enhancing miscibility of this polyol with other polyols in the reactive mixture. Further (meth)acrylate monomers can also be included, as needed, to optimize the mechanical properties of the first clear coat layer 104.

The reactive mixture used to make the first clear coat layer 104 can further include any number of additional polyols, which are inclusive of diols and polyols with a hydroxyl functionality of greater than two. Suitable polyols can include caprolactone polyols, polycarbonate polyols, polyester polyols, polyacrylate polyols, polyether polyol, polyolefin polyol, and mixtures thereof. The addition of these additional polyols can be beneficial in adjusting the T_{g} and overall mechanical properties of the first clear coat layer 104. The additional polyols can represent from 20 percent to 80 percent by weight, or in some embodiments, less than, equal to, or greater than 20 percent, 22, 25, 27, 30, 32, 35, 37, 40, 42, 45, 46, 50, 55, 57, 60, 62, 65, 67, 70, 72, 75, 77, or 80 percent by weight of the overall weight of the reactive mixture used to make the first clear coat layer 104.

Collectively, the polyol components used in making the first clear coat layer 104, can account for from 25% to 80%, from 30% to 70%, from 30% to 60%, or in some embodiments, less than, equal to, or greater than, 25%, 30, 35, 40, 45, 50, 55, 60, 65, 70, 75, or 80% by weight, relative to the overall weight of the uncured polyurethane composition.

Suitable isocyanates include diisocyanates and polyisocyanates with an isocyanate functionality of greater than 2. In exemplary embodiments, the polyisocyanate is a primary polyisocyanate, such as a primary aliphatic polyisocyanate. Primary polyisocyanates having an isocyanate functionality of 3 or more can be made from primary diisocyanates, such as 1,6-hexamethylene diisocyanate, trimethyl-hexamethylene diisocyanate, 1,4-tetramethylene diisoycanate, 1,3-xylene diisocyanate, 1,4-xylene diisocyanate, 1,12-dodecamethylene diisocyanate, 2-methylpentamethylene diisocyanate, or 1,4-cyclohexane dimethylene diisocyanate.

The polyisocyanate can represent from 30% to 90%, from 40% to 80%, from 50% to 70%, or in some embodiments, less than, equal to, or greater than, 30%, 35, 40, 45, 50, 55, 60, 65, 70, 75, 80, 85, or 90% by weight, relative to the overall weight of the uncured polyurethane composition.

The curable composition can further include a catalyst to facilitate reaction between the polyisocyanate and polyol components. Useful catalysts in the polymerization of polyurethanes include aluminum-, bismuth-, tin-, vanadium-, zinc-, mercury-, and zirconium-based catalysts, amine catalysts, and mixtures thereof. Preferred catalysts include tin based catalysts, such as dibutyl tin compounds. Especially preferred are catalysts selected from the group consisting of dibutyltin diacetate, dibutyltin dilaurate, dibutyltin diacetylacetonate, dibutyltin dimercaptide, dibutyltin dioctoate, dibutyltin dimaleate, dibutyltin acetonylacetonate, and dibutyltin oxide.

Suitable amounts of the catalyst can be from 0.001% to 0.2%, from 0.001% to 0.15%, from 0.001% to 0.1%, or in some embodiments, less than, equal to, or greater than 0.001%, 0.002, 0.005, 0.007, 0.01, 0.02, 0.05, 0.07, 0.1, 0.12, 0.15, 0.17, or 0.2% by weight, based on the overall weight of the uncured polyurethane composition.

If desired, other components can also be included in the first curable clear composition, such as ultraviolet light absorbers, hindered amines, leveling agents, colorants, flame retardants, and pot life extenders.

An organic solvent can be used to adjust the viscosities of the reactive mixture used to make the first clear coat layer 104. Such solvents can include ether acetate, propyleneglycol monomethylether acetate, ketone, benzene derivatives, and mixtures thereof. The amount of solvent can be selected to facilitate adequate mixing and casting of the curable polyurethane composition. The organic solvent used is generally volatile so that it can be removed prior to, or concurrently with, the curing of the first clear coat layer 104. Such evaporation could be facilitated by heat, vacuum, or both.

When the foregoing reactive components are mixed and sufficiently heated, they polymerize into a crosslinked network. The crosslink density of a polyurethane is calculated by dividing the weight of the reaction components having a functionality of 3 or greater by the total weight of the polyurethane and multiplying by 100. High crosslink densities, for example exceeding 30 percent, are generally associated with rigid polyurethane materials. Use of a primary aliphatic polyisocyanate, however, can enable polyurethanes that are both flexible and have a high crosslink density. Useful crosslink densities can be from 25% to 100%, from 30% to 100%, or in some embodiments, less than, equal to, or greater than 25%, 30, 35, 40, 45, 50, 55, 60, 65, 70, 75, 80, 85, 90, or 95, or less than or equal to 100%.

The ultimate thickness of the first clear coat layer 104 can vary as needed for the end application. Typically, the thickness of the first clear coat layer 104 is from 2 micrometers to 25 micrometers, from 2 micrometers to 20 micrometers, from 2 micrometers to 15 micrometers, or in some embodiments, less than, equal to, or greater than 2 micrometers, 3, 4, 5, 6, 7, 8, 9, 10, 12, 15, 17, 20, 22, or 25 micrometers.

The second clear coat layer 106 extends along and flatly contacts the bottom surface 110 of the first clear coat layer 104. The second clear coat layer 106 is made by at least partially curing a second polyurethane composition. Use of a second polyurethane composition that is only partially crosslinked (i.e., partially cured) can be advantageous when the second clear coat layer 106 is used as a primer to enhance adhesion with the first clear coat layer 104. In some embodiments, secondary bonding (e.g., hydrogen bonding) occurs at the interface between the first and second polyurethane clear coat layers, resulting in increased interlayer adhesion. In some embodiments, as will be later described, the first clear coat layer 104 can also be only partially cured when the two layers are brought together.

The second polyurethane composition can have characteristics similar to that of the first polyurethane composition as described above, but differs from the first polyurethane composition in that it does not contain a polyol containing a styrene repeat unit and a hydroxyl-containing (meth)acrylate repeat unit.

In some embodiments, the second polyurethane composition is a water-borne polyurethane dispersion. Preferred water-borne polyurethane dispersions include aliphatic polycarbonate polyurethane dispersions. The dispersion can use a solvent system that includes water and one or more co-solvents. Certain co-solvents, such as diethylene glycol monomethyl ether, can be helpful to improve coating quality by reducing volatility of the dispersion.

The polyurethane dispersion can include any of a number of suitable surfactants, such as anionic surfactants. Anionic surfactants include, for example, sulfates such as sodium dodecyl sulfate, ammonium dodecyl sulfate, and sodium lauryl ether sulfate, and sulfosuccinnates such as dioctyl sodium sulfosuccinate and disodium lauryl sulfosuccinate. In water-borne polyurethanes such as described above, these surfactants can be used in combination with co-dispersants. Co-dispersants include amino alcohols. Amino alcohols, such as 2-amino-2-methyl-1-propanol, can assist in neutralizing acid-functional resins, making them suitable for use in water-borne coatings.

The second polyurethane composition can include any suitable crosslinker, such as a polyfunctional aziridine liquid crosslinker. The amount of crosslinker is not critical and can be selected to provide the desired degree of crosslinking. The amount of crosslinker can be from 0.5% to 5%, from 0.5% to 4%, from 0.5% to 3%, or in some embodiments, less than, equal to, or greater than 0.5%, 0.6, 0.7, 0.8, 0.9, 1, 1.1, 1.2, 1.5, 1.7, 2, 2.2, 2.5, 2.7, 3, 3.2, 3.5, 3.7, 4, 4.2, 4.5, 4.7, or 5% by weight relative to the overall weight of the second polyurethane composition.

While not critical, other additives such as UV light absorbers and stabilizers can also be included in either or both of the first and second polyurethane compositions. Stabilizers can include hindered amine light stabilizers that eliminate free radicals produced by photo-oxidation of the polymer. Advantageously, these additives can help minimize defects caused by cracking and gloss reduction in the clear coat layer.

In a preferred embodiment, the water-borne polyurethane dispersion is a polycarbonate polyurethane having a solids content of from 30-40 wt % and an overall solvent content of from 5-15 wt %.

The second clear coat layer 106 has a chemical composition capable of permanently adhering to the first clear coat layer 104. Preferably, the first and second clear coat layers 104, 106 do not delaminate from each other during the lifetime of the surfacing film 100, even under harsh environments. Advantageously, the provided surfacing film 100 uses a second clear coat layer 106 that can be strongly adhered to a previously made first clear coat layer 104 obtained by curing a reactive mixture such as described in the foregoing.

The thickness of the second clear coat layer 106 need not be particularly restricted. In some embodiments, this thickness can be similar to that of the first clear coat layer 104. Typically, the film thickness of the second clear coat layer 106 when cured is from 2 micrometers to 30 micrometers, from 2 micrometers to 25 micrometers, from 2 micrometers to 15 micrometers, or in some embodiments, less than, equal to, or greater than 2 micrometers, 3, 4, 5, 6, 7, 8, 9, 10, 12, 15, 17, 20, 22, 25, 27, or 30 micrometers.

Referring again to FIG. 1, the composite clear coat layer 102 is disposed on a bulk layer 112 that extends across and continuously contacts the bottom surface of the second clear coat layer 106.

In a preferred embodiment, the bulk layer 112 is comprised of a thermoplastic polyurethane. However, it is also possible for the bulk layer 112 to be made from a polyester and/or polyolefin such polypropylene, polyethylene and blends of polyethylene and polypropylene, ethylene modified copolymers such as ethylene-vinylacetate, ethylene-(meth)acrylic acid, ethylene-methacrylate or a blend thereof. Useful bulk layer compositions for surfacing films that protect exterior surfaces of an automobile include ionomers of olefin/vinyl carboxylate copolymers such as ethylene-acrylic acid and ethylene-methacrylic acid copolymers combined with various metal cations including cations of lithium, sodium, potassium, zinc, aluminum and calcium. Suitable commercial ionomer resins include materials available from E.I. DuPont de Nemours & Co. of Wilmington, DE under the trade designation SURLYN.

In a preferred embodiment, the bulk layer 112 is an aliphatic thermoplastic polyurethane, which can provide excellent optical characteristics, high flexibility, good heat and UV resistance, and good chip resistance.

The thickness of the bulk layer 112 is not particularly restricted. Preferably sufficiently thin to allow the overall surfacing film 100 to stretch as needed to conform to a substrate having three-dimensional contours that are curved or irregularly shaped, and yet sufficiently thick to protect the substrate against scratches and impacts encountered in use. The thickness of the bulk layer 112 can be from 50 micrometers to 500 micrometers, from 50 micrometers to 500 micrometers, from 50 micrometers to 350 micrometers, or in some embodiments, less than, equal to, or greater than 50 micrometers, 60, 70, 80, 90, 100, 125, 150, 175, 200, 225, 250, 270, 300, 325, 350, 375, 400, 450, or 500 micrometers.

An adhesive layer 114 extends across and directly contacts the major surface of the bulk layer 112 facing away from the first and second clear coat layers 104, 106. The adhesive layer 114 can be a pressure sensitive adhesive and is normally tacky at ambient conditions. Suitable pressure sensitive adhesives can be based on polyacrylates, synthetic and natural rubbers, polybutadiene and copolymers or polyisoprenes and copolymers. Optionally, silicone based such adhesives as polydimethylsiloxane and polymethylphenylsiloxane may also be used.

Particularly preferred pressure sensitive adhesives include polyacrylate-based adhesives, which can display advantageous properties as high degrees of clarity, UV-stability and aging resistance. Polyacrylate adhesives that can be used in surfacing film applications are described, for example, in U.S. Pat. No. 4,418,120 (Kealy et al.); RE24,906 (Ulrich); U.S. Pat. No. 4,619,867 (Charbonneau et al.); 4,835,217 (Haskett et al.); and International Publication No. WO 87/00189 (Bonk et al.).

Preferably, the polyacrylate pressure sensitive adhesive comprises a crosslinkable copolymer of a C4-C12 alkyl acrylate and an acrylic acid. The adhesive can be used with or without a crosslinker. Useful crosslinking reactions include chemical crosslinking and ionic crosslinking. The chemical crosslinker could include polyaziridine and/or bisamide and the ionic crosslinker may include metal ions of aluminum, zinc, zirconium, or a mixture thereof. A mixture of chemical crosslinker and ionic crosslinker can also be used. In some embodiments, the polyacrylate pressure sensitive adhesive includes a tackifier such as rosin ester. Adhesives useful in the invention may also contain additives such as ground glass, titanium dioxide, silica, glass beads, waxes, tackifiers, low molecular weight thermoplastics, oligomeric species, plasticizers, pigments, metallic flakes and metallic powders as long as they are provided in an amount that does not unduly degrade the quality of the adhesive bond to the surface.

As an alternative to pressure sensitive adhesives, the adhesive layer 114 may be a hot melt adhesive, which is not tacky at room temperature but becomes tacky upon heating. Such adhesives include acrylics, ethylene vinyl acetate, and polyurethane materials.

Generally, the adhesive layer 114 can have a thickness of from 15 micrometers to 60 micrometers, from 15 micrometers to 50 micrometers, from 15 micrometers to 45 micrometers, or in some embodiments, less than, equal to, or greater than 15 micrometers, 17, 20, 22, 25, 27, 30, 35, 40, 45, 50, 55, or 60 micrometers.

For certain applications, such as applying the surfacing film 200 to an automotive exterior, it may be desirable for the adhesive to be repositionable, at least initially, so that the sheet can be adjusted to fit at a desired place before a permanent bond is formed. Such repositionability may be achieved by providing, for example, a layer of minute glass bubbles on the adhesive surface as disclosed in U.S. Pat. No. 3,331,729 (Danielson et al.).

FIG. 2 shows a surfacing film 200 according to an alternative embodiment. Like the surfacing film 100, the surfacing film 200 includes a composite clear coat layer 202 that includes a first clear coat layer 204 and a second clear coat layer 206, along with an adhesive layer 214 on the opposing major surface of the surfacing film 200.

Unlike the prior embodiment, however, the composite clear coat layer 202 is disposed on a composite bulk layer. The composite bulk layer depicted has a dual-layered construction including a transparent bulk layer 213 and a colored bulk layer 212. Optionally, both the transparent bulk layer 213 and the colored bulk layer 212 can be made using the same matrix polymer, such as any of the thermoplastic polyurethanes, polyesters, polyolefins, or blends thereof, as previously described. In a preferred embodiment, the colored bulk layer 212 contains a sufficient amount of colorant to suffuse the layer with color, while the transparent bulk layer 213 is essentially devoid of any colorant. Useful colorants are not restricted and can include any dyes or pigments known in the art, including metallic flakes and pearlescent pigments. The amount of colorant in the colored bulk layer 212 is also not restricted and may be sufficient to render this layer opaque. In an alternative embodiment, the transparent bulk layer 213 is replaced with a translucent colored layer, such as a lightly filled pearlescent pigmented layer. In this case, the colored bulk layer 212 could be, for instance, a white pigmented base layer whose pigment loading is substantially higher than that of the pearlescent pigmented layer.

According to yet another embodiment, though not explicitly illustrated here, the colored bulk layer 212 may itself include two or more constituent sublayers. For example, the colored bulk layer 212 can include a base sublayer underneath a colored sublayer, both of which extend beneath the transparent bulk layer 213. Based on the selection and loading of pigments, the colored sublayer could be made translucent, while the base sublayer could be made substantially opaque or reflective. As a further example, the base sublayer could contain light-absorbing or reflective metallic flakes and the colored sublayer could be translucent and contain a pearlescent pigment.

Advantageously, use of such a multilayered bulk layer enables the surfacing film to show an enhanced visual perception of depth to an observer, thereby providing improved aesthetics. This depth perception is provided by the transparent bulk layer 213, which effectively extends the visually apparent depth of the composite clear coat layer 202, while the colored bulk layer 212 preserves the desired background of the surfacing film 200. Because the highly crosslinked nature of the first clear coat layer 204 tends to have a strong stiffening effect, this construction can provide this enhanced depth perception without negatively impacting the handling properties of the overall surfacing film 200.

In those embodiments that use a dual-layered bulk layer, the relative proportions between the transparent bulk layer 213 and the colored bulk layer 212 can be varied according to the visual effect desired. The transparent bulk layer 213 can have a thickness of from 25 micrometers to 125 micrometers, or in some embodiments, less than, equal to, or greater than 25 micrometers, 30, 35, 40, 45, 50, 60, 70, 80, 90, 100, 105, 110, 115, 120, or 125 micrometers. The colored bulk layer 212 can have a thickness of 25 micrometers to 375 micrometers, or in some embodiments, less than, equal to, or greater than 25 micrometers, 30, 35, 40, 45, 50, 55, 60, 70, 80, 90, 100, 125, 150, 175, 200, 225, 250, 275, 300, 325, 350, or 375 micrometers.

### Processes of Manufacture

Significant technical advantages provided by the provided surfacing films and related processes derive from improvements in throughput, web handling, and quality control in manufacturing these films.

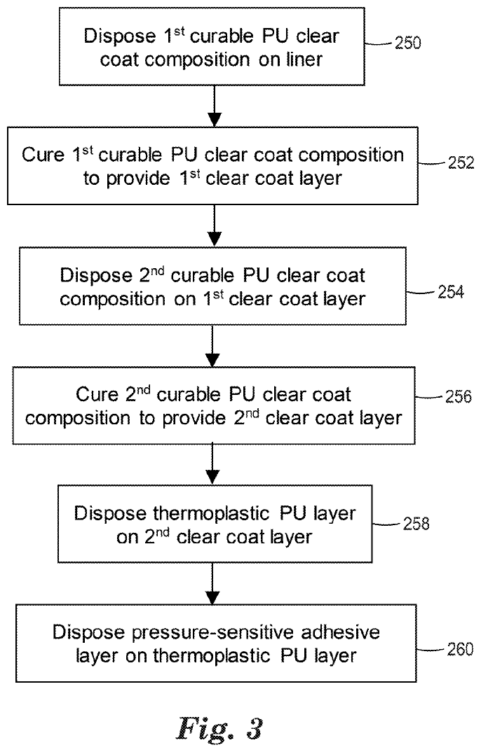

An exemplary process of making the provided surfacing films is provided in the block diagram of FIG. 3.

In block 250, a first curable polyurethane clear coat composition is disposed onto a release liner or other release surface. This clear coat composition is a liquid and can be coated using any known technique. Suitable techniques include, for example, coating or extruding onto the release liner. Coating and extruding of the disclosed curable clear coat compositions can take place using either batch or continuous techniques.

In an exemplary extrusion process, the components of the first curable polyurethane clear coat composition are initially mixed into two separate parts to prevent premature reaction. One part can be prepared by first mixing the polyol components, a suitable solvent (if needed), and any optional additives. The other part contains the isocyanate component along with any solvent or optional additives. The first and second parts are then mixed in appropriate amounts to obtain a desired NCO:OH ratio. In these embodiments, the NCO:OH ratio can be selected to be between 0.75 and 1.25.

Once mixed, the composition can be coated onto a release surface, such as a polyester release liner. The coating can be made using conventional equipment such as a knife coater, roll coater, reverse roll coater, notched bar coater, curtain coater, rotogravure coater, or rotary printer. Coatings can be hand spread or automated and may be carried out according to either a batch or continuous process. The viscosity of the composition can be adjusted as needed to suit the type of coater used.

As provided in block 252, the first curable polyurethane clear coat composition is then cured. This can be achieved by subjected the clear coat composition to heat and/or vacuum to remove organic solvents and any other volatile components and thermally activate the curing reaction between the polyol and isocyanate and partially cure clear coat composition. In some embodiments, the first curable polyurethane clear coat composition is 45% to 55% cured, 40% to 60% cured, from 30% to 70% cured, or in some embodiments, less than, equal to, or greater than 30%, 35, 40, 45, 50, 55, 60, 65, or 70% cured.

The partial curing of the first curable clear coat composition was found to improve adhesion of the second clear coat layer to the first clear coat layer, particularly when the second curable polyurethane clear coat composition is disposed onto the partially-cured first curable clear coat composition and both layers cured together. By contrast, fully curing the first curable clear coat composition was observed to reduce adhesion of the first and second clear coat layers to each other.

An oven can be used to first evaporate the solvent and partially cure the composition. Commonly, the drying/curing step takes place in air. Where a continuous process is used, these processes can act upon a moving web. In an exemplary continuous process, a 0.0076 centimeter (0.003 inch) thick wet coating could have a solids content of about 45%, and be dried and cured using a temperature profile with a residence time of 2 minutes at 80° C. followed by a residence time of 10 minutes at 125° C.

In general, the clear coat composition is preferably dried and/or cured at pre-determined temperatures of from 25° C. to 150° C., or in some embodiments, less than, equal to, or greater than 25° C., 30, 35, 40, 45, 50, 55, 60, 65, 70, 75, 80, 85, 90, 95, 100, 105, 110, 115, 120, 125, 130, 135, 140, 145, or 150° C. Residence time at a given temperature, while highly dependent on the temperature, can be from 5 seconds to 180 seconds, 5 seconds to 150 seconds, 5 seconds to 120 seconds, or in some embodiments, less than, equal to, or greater than 5 seconds, 10, 15, 20, 25, 30, 35, 40, 45, 50, 60, 70, 80, 90, 100, 110, 120, 130, 140, 150, 160, 170, or 180 seconds. The clear coat composition is preferably subjected to residence times and temperatures, or temperature ranges, that balance solvent removal and curing effectiveness with overall throughput and energy efficiency.

In block 254, a second curable polyurethane clear coat composition is disposed on the partially-cured first clear coat layer, which at this time is still supported on a release liner. The second curable polyurethane clear coat composition can be a water-borne polyurethane dispersion or emulsion. Commercially available polyurethane dispersions and emulsions include, for example, those made by Alberdingk Boley, Inc., Greensboro, NC.

Any known method can be used to dispose the second curable polyurethane clear coat composition on the underlying layer, including any of those mentioned above for coating the first curable polyurethane clear coat composition.

In block 256, the second curable polyurethane clear coat composition is cured to provide a second clear coat layer. Typically, heat is again applied to evaporate the water and/or any other volatiles species, and then cure the first and second clear coat layers. Oven temperature profiles can be similar to those disclosed above for partially curing the first curable polyurethane clear coat composition. Since the degree of cure need not be limited for this second curing cycle, however, it can be advantageous to use a higher temperature or increase the duration of the curing step if temperature is not significantly increased.

In some embodiments, the first and second clear coat layers are allowed to continue to cure having been cooled following the heating step and prior to any further coating or lamination steps. This can be accomplished by aging the composite clear coat layer at ambient conditions. Aging can take place for at least 1 week, at least 2 weeks, at least 3 weeks or at least 4 weeks to allow the first and second clear coat layers to reach a generally stable and consistent degree of crosslinking.

Block 258 shows the next step, in which the one or more thermoplastic polyurethane bulk layers are disposed onto the exposed major surface of the second clear coat layer. If there are two or more thermoplastic polyurethane bulk layers, such as in the surfacing film 200 of FIG. 2, then the individual layers can be made simultaneously (e.g., by coextrusion) or alternatively made at different times and later combined.

By this time, both the first and second clear coat layers have been functionally cured. In some embodiments, the thermoplastic polyurethane layer can be melt processed and extruded directly onto the composite clear coat layer from the melt. In alternative embodiments, the thermoplastic polyurethane layer can be melt processed and formed into a uniform film separately, then subsequently thermally laminated to the composite clear coat layer.

As indicated in block 260, a pressure-sensitive adhesive layer of an above composition can then be disposed onto the thermoplastic polyurethane layer. Like the bulk layer, the adhesive layer can be directly coated onto the remaining layers of the surfacing film or formed into an adhesive film and then laminated to the bulk layer in a subsequent step. In the latter case, a sacrificial release liner is typically placed in contact with the adhesive layer to facilitate web handling and storage. In other embodiments, adhesives other than pressure-sensitive adhesives can be used in place of the pressure-sensitive adhesive layer in block 260.

Optionally, the steps of blocks 258 and 260 can be carried out in reverse order. For example, the pressure-sensitive adhesive and polyurethane bulk layer can be provided together on a release liner, and then the clear coat layers collectively laminated to the polyurethane bulk layer/adhesive/liner to obtain the finished surfacing film.

A significant advantage to disposing the bulk layer on the composite clear coat layer after the latter has been essentially fully cured is the reduction, or even elimination, of impurities in the polyurethane bulk layer and/or pressure-sensitive adhesive. This benefit results from driving out essentially all solvents and other volatile compounds from the composite clear coat layer before it is placed in contact with the remaining layers. By contrast, the conventional method disposes an uncured clear coat composition onto the bulk layer. As a result, solvent from the uncured clear coat composition can permeate into the bulk layer. This in turn can cause significant softening of the bulk layer, allowing impurities in the bulk layer, such as waxes and anti-sticking agents, to also migrate into the adjacent pressure-sensitive adhesive layer and degrade bond performance.

Unexpectedly, reducing/eliminating the migration of small molecules into the bulk layer also had the effect of providing a more stable stiffness in the surfacing film. Since the bulk layer is made from a thermoplastic polyurethane, it is prone to stiffening as a result of isocyanate-based crosslinkers migrating along with solvents and other additives from the first clear coat layer, through the second clear coat layer and into the bulk layer. This can result in light crosslinking of the bulk layer over a period of 2 to 3 months. Since this occurs during storage, it results in the end product having inconsistent film stiffness, which is undesirable. This phenomenon can be observed by attempting to dissolve the thermoplastic bulk layer in a suitable solvent; if this layer is partially crosslinked, it will not completely dissolve.

Yet another advantage of the foregoing process is the possibility of staging the manufacture of layers in the surfacing film. Constituent layers can be manufactured continuously in successive stages on inexpensive release liners. When the composite clear coat layer is made first, it is possible to optimize extrusion of the bulk layer on an inexpensive release liner, then substitute the release liner with the composite clear coat layer to merge the layers. A similar process can be used to apply the adhesive layer to the bulk layer. This refinement can significantly improve product yield and minimize waste of polyurethane film.

### Applications and Properties

The provided surfacing films are useful in paint protection and paint replacement applications. These films can be applied to any of a wide variety of substrates. Such substrates may be flat or curved. When it is desired to adhere these articles to such curved surfaces, it is preferable that the surfacing film has sufficient flexibility to conform to the surface of the substrate without delaminating at the edges or wrinkling.

Common substrates suitable for protection include, for example, bumper facia, pillar posts, rocker panels, wheel covers, headlights, door panels, trunk and hood lids, mirror housings, dashboards, floor mats, and door sills. In an exemplary process of application, a surfacing film can be mounted to a suitable substrate by simultaneously peeling away the release liner from the adhesive layer while applying the film onto the substrate in a single continuous motion.

In some embodiments, the provided surfacing film is applied to the exterior surfaces of automobiles, trucks, motorcycles, trains, airplanes, rotorcraft, marine vehicles, and snowmobiles. In alternative embodiments, the surfacing films can be applied to surfaces of structures other than vehicles, such as fixtures, buildings and architectural surfaces. Applications of these films may be either indoor or outdoor in nature. The provided surfacing films are especially advantageous outdoors not only because of their low surface energy and easy cleaning properties, but because they display excellent weathering, chemical and abrasion resistance while remaining highly flexible.

In some embodiments, the surfacing film has an exposed top surface. Advantageously, the first clear coat layer 104 provides a combination of desirable optical and mechanical properties rendering it especially suitable as an outermost layer in protective film applications.

The optical properties of a clear coat layer or surfacing film can be characterized by its measured light transmission and haze values. It is generally desirable to have the lowest haze possible for clear coat applications. Transmission and haze values for clear coat layer samples can be obtained, for example, using a Haze-Gard Plus instrument available from BYK Gardner USA of Columbia, MD. The cured clear coat layer or surfacing film preferably displays a haze that is less than 6%, less than 5%, less than 4%, less than 3.5%, or less than 3%, as measured according to the Haze Test, as described in U.S. Pat. No. 10,711,156 (Ho et al.). The cured first clear coat layer 104 also exhibits a stain-resistant clear coat surface.

### EXAMPLES

Objects and advantages of this disclosure are further illustrated by the following non-limiting examples, but the particular materials and amounts thereof recited in these examples, as well as other conditions and details, should not be construed to unduly limit this disclosure. Unless otherwise noted, all parts, percentages, ratios, etc. in the Examples and the rest of the specification are by weight.

TABLE 1
Materials

| Designation | Description | Source |
|---|---|---|
| AA | 2,4-Pentanedione available under the | Alfa Aesar, Haverhill, |
| | designation “Acetylacetone” | MA, United States |
| AMP-95 | 2-amino-2-methyl-1-propanol containing | ANGUS Chemical |
| | 5% added water available under the | Company, Buffalo |
| | designation AMP-95 | Grove, IL, United |
| | | States |
| BA | Ester solvent available under the | Alfa Aesar |
| | designation “Butyl Acetate” | |
| BC | Hydrophilic glycol ether under the | The Dow Chemical |
| | designation “Butyl Carbitol” | Company, Midland, |
| | | MI. United States |
| CAPA-2054 | A low molecular weight, | Perstorp, Malmö, |
| | polycaprolactone polyol diol available | Sweden |
| | under the trade designation “CAPA | |
| | 2054” | |
| CAPA-3031 | A low molecular weight, | Perstorp, Malmö, |
| | polycaprolactone polyol triol available | Sweden |
| | under the trade designation “CAPA | |
| | 3031” | |
| C-381 | Cellulose acetate butyrate ester with | Eastman Chemicals, |
| | medium butyryl content and low | Kingsport, TN. |
| | viscosity available under the designation | United States |
| | “CAB 381-0.1” | |
| CX-100 | A 100% active polyfunctional aziridine | DSM Coating Resins, |
| | liquid crosslinker available under the | LLC, Wilmington, |
| | designation “Neocryl ® CX-100” | MA, United States |
| F55-112 | A hydroxyl terminated saturated linear | Chemtura |
| | polyester available under the designation | Corporation |
| | “Fomrez ® 55-112” | Middlebury, CT, |
| | | United States |
| F55-225 | A hydroxyl terminated saturated linear | Chemtura |
| | polyester available under the designation | Corporation |
| | “Fomrez ® 55-225” | |
| GR-7M | Anionic surfactant available under the | The Dow Chemical |
| | trade designation TRITON GR-7M | Company |
| J587-AC | An acrylic polyol available under the | BASF Corporation, |
| | designation Joncryl ® 587-AC | Southfield, MI. |
| | | United States |
| MIBK | Medium evaporating solvent available | Sigma Aldrich, St. |
| | under the designation “Methyl Isobutyl | Louis, MO, United |
| | Ketone (MIBK)” | States |
| N3039 | An ultraviolet light absorber (UVA) | BASF Corporation |
| | available under the designation “Uvinul ® | |
| | N-3039) | |
| N3390 | Aliphatic polyisocyanate available under | Covestro AG, |
| | the designation “DESMODUR N3390 | Leverkusen, Germany |
| | BA/SN” | |
| PMA | Propylene glycol monomethyl ether | Alfa Aesar |
| | acetate slow evaporating solvent | |
| | available under the designation “PM | |
| | Acetate” | |
| S17-1608 | A hydroxy functional acrylic resin | Allnex, Frankfurt, |
| | available under the designation | Germany |
| | “SETALUX ® 17-1608 | |
| T-12 | Dibutyltin dilaurate DBTDL catalyst | Air Products, |
| | available under the trade designation | Allentown, PA, |
| | “DABCO T-12” | United States |
| T-123 | Liquid hindered amine light stabilizer | BASF Corporation |
| | (HALS) available under the trade | |
| | designation “TINUVIN 123” | |
| T-292 | Liquid hindered amine light stabilizer | BASF Corporation |
| | (HALS) available under the trade | |
| | designation “TINUVIN 292” | |
| T-405 | Solid triazine-based ultraviolet (UV) | BASF Corporation |
| | absorber available under the trade | |
| | designation “TINUVIN 405” | |
| T-479 | A hydroxyphenyl-triazine (HPT) UV | BASF Corporation |
| | absorber under the trade designation | |
| | “TINUVIN 479” | |
| U933 | An aqueous, colloidal, low viscous | Alberdingky Boley, |
| | dispersion of an aliphatic polycarbonate- | Inc., Greensboro, NC, |
| | polyurethane available under the | United States |
| | designation “ALBERDINGK ® U 933” | |
| U9190 | Aliphatic polycarbonate polyurethane | Alberdingky Boley, |
| | available under the designation | Inc. |
| | “ALBERDINGK ® UL9190” | |
| Xylene | Aromatic hydrocarbon solvent | Azer Scientific, Inc, |
| | | Morgantown, PA. |
| | | United States |

### Test Methods

### Stain

The adhesive-side of the sample was adhered to a standard RK8014 clear coated white painted panel available from ACT Test Panels Technologies of Hillsdale, MI, United States. A 2.54 cm (1 inch) diameter of a staining fluid was placed on the sample and left to age for 24 hours at 23.9° C. (75° F.). After 24 hours, the samples were cleaned with painters' naphtha (VM&P Naphtha, from Ashland Chemical Co., Covingto, KY. United States). Yellowing (Δb) and total color change (ΔE) were measured before and after staining using a colorimeter. The test was conducted using a staining fluid that was prepared by mixing 50 volume % of AC-20 non-emulsified asphalt cement (Marathon Petroleum Company from Findlay, OH. United States) in unleaded gasoline. Samples were dipped into the staining fluid for ten seconds and then suspended in a ventilated hood chamber for fifteen minutes to allow the staining fluid to evaporate. The samples were cleaned with painters' naphtha. As testing was conducted, odor was as noted and textual comments were captured as to whether an odor was detected or not.

### Example 1 (EX1)

A first reactive polyurethane clear coating solution was prepared by mixing 6.8 grams of CAPA-2054, 27.2 grams of J587-AC, 0.43 grams of T-405, 0.35 grams of T-292, 0.43 grams of T-479, 19.75 grams of PMA, 23.0 grams of BA, 19.84 grams of Xylene, 2.20 grams of C-381, 11.72 grams of N3390, and a 0.9 gram mixture of AA with T-12 at a ratio of 97.5:2.5. The mixture of clear coat solution was thoroughly agitated for fifteen minutes, and the solution was coated on melamine acrylic primed polyester release carrier web by a 27.94 cm (11-inch) wide die coater. The solution flow rate was controlled at 45 grams per minute and line speed was at 3.66 meters per minute (12 feet per minute). The reactive polyurethane clear coat was cured at 115.56° C. (240° F.) in an air oven. The resulting first clear coat dry thickness was about eight micrometers.

A second reactive polyurethane clear coating solution was prepared by mixing 83.78 grams of U9190, 0.35 grams of T-123, 0.03 grams AMP-95, 0.19 grams of GR-7M, 8.47 grams of BC, 1.08 grams of T-405, 0.45 grams of T-292, 14.0 grams of de-ionized water, and 2.0 grams of CX-100. The solution mixture was thoroughly mixed for about fifteen minutes. The solution mixture of the second reactive polyurethane clear coat was then coated on the first reactive polyurethane clear coat at a flow rate of 40 grams per minute and at 3.66 meters per minute (12 feet per minute). The dual layer clear coat was cured in an air oven as it advanced through three temperature zones of 93.33° C. (200° F.), 121.11° C. (250° F.) and 135° C. (275° F.). The oven resident time in each zone was about 38 seconds. The second clear coat dry thickness was about twelve micrometers.

The dual layer clear coat was then thermally laminated to a surface protection urethane film (obtained from 3M Company of St. Paul, MN. United States), which comprised a layer of urethane film, adhesive (isoactyl acetate/acrylic acetate/vinyl acetate), and polyester release liner. The hot can temperature was set at 112.78° C. (235° F.), nip roll pressure was set at 275.79 kPa (40 psi), and line speed was 4.57 meters per minute (15 feet per minute). The polyester carrier web on the first reactive polyurethane clear coat surface was removed after 24 hours. The dual layer clear coat-based paint protection film was aged at room temperature for four weeks before conducting tests. Stain testing was conducted, and the results are represented in Table 2.

### Example 2 (EX2)

A first reactive polyurethane clear coating solution was prepared by mixing 4.0 grams of F55-112, 4.0 grams of F55-225, 4.0 grams of CAPA-3031, 15.0 grams of S17-1608, 1.0 gram of T-405, 0.5 grams of T-292, 13.3 grams of PMA, 23.3 grams of BA, 80.5 grams of MIBK, 10.0 grams of Xylene, 2.50 grams of C-381, 18.73 grams of N3390, and a 1.9 gram mixture of AA with T-12 at a ratio of 97.5:2.5. The mixture of clear coat solution was thoroughly agitated for fifteen minutes, and the solution was coated on melamine acrylic primed polyester release carrier web by a 27.94 cm (11-inch) wide die coater. The solution flow rate was controlled at 35 grams per minute and line speed was at 7.62 meters per minute (25 feet per minute). The reactive polyurethane clear coat was cured at 143.33° C. (290° F.) in an air oven with total resident time about 84 seconds. The resulting first clear coat dry thickness was about 4.0 micrometers.

A second reactive polyurethane clear coating solution was prepared by mixing 89.30 grams of U933, 0.35 grams of T-123, 0.05 grams AMP-95, 0.20 grams of GR-7M, 8.5 grams of BC, 1.16 grams of N3039, 38.0 grams of de-ionized water, and 1.78 grams of CX-100. The solution mixture was thoroughly mixed for about fifteen minutes. The solution mixture of the second reactive polyurethane clear coat was then coated on the first reactive polyurethane clear coat at a flow rate of 40 grams per minute and at 6.09 meters per minute (20 feet per minute). The clear coat was cured in an air oven as it advanced through two temperature zones of 107.22° C. (225° F.) and 143.33° C. (290° F.). The oven resident time in each zone was about 54 seconds. The second clear coat dry thickness was about 6.13 micrometers.

The dual layer clear coat was then thermally laminated to a surface protection urethane film (obtained from 3M Company), which comprised a layer of urethane film, adhesive (isoactyl acetate/acrylic acetate/vinyl acetate), and polyester release liner. The hot can temperature was set at 112.78° C. (235° F.), nip roll pressure was set at 275.79 kPa (40 psi), and line speed was 4.57 meters per minute (15 feet per minute). The polyester carrier web on the first reactive polyurethane clear coat surface was removed after 24 hours. The dual layer clear coat-based paint protection film was aged at room temperature for four weeks before conducting tests. Stain testing was conducted, and the results are represented in Table 2.

### Comparative Example 1 (CE1)

The solvent-based clear coat (assembled as described in EX1 or EX2) was coated directly on a standard urethane film (obtained from 3M Company of St. Paul, MN. United States), which comprised a layer of 125-micrometer urethane film, a 35-micrometer standard adhesive (isoactyl acetate/acrylic acetate/vinyl acetate) layer, and a polyester release liner and cured in an air oven at 146.11° C. (295° F.).

### Comparative Example 2 (CE2)

Stain testing was conducted on ULTIMATE PLUS Film (obtained from XPEL, Inc of San Antonio, TX. United States) and results are represented in Table 2.

### Comparative Example 3 (CE3)

Staining testing was conducted on Extreme Film (obtained from XPEL, Inc of San Antonio, TX. United States) and results are represented in Table 2.

### Comparative Example 4 (CE4)

Stain testing was conducted on PPF Clear Film (obtained from SUNTEK a subsidiary of Eastman Performance Films of Martinsville, VA. United States) and results are represented in Table 2.

TABLE 2
Stain Testing Results

| | EX1 | EX2 | CE1 | CE2 | CE3 | CE5 |
|---|---|---|---|---|---|---|
| Δb | 0.71 | 0.80 | 2.04 | 1.13 | 4.6 | 2.54 |
| ΔE | 0.76 | 0.89 | 2.2 | 1.24 | 5.1 | 2.75 |
| Odor | No | No | Yes | Yes | Yes | Yes |

All cited references, patents, and patent applications in the above application for letters patent are herein incorporated by reference in their entirety in a consistent manner. In the event of inconsistencies or contradictions between portions of the incorporated references and this application, the information in the preceding description shall control. The preceding description, given in order to enable one of ordinary skill in the art to practice the claimed disclosure, is not to be construed as limiting the scope of the disclosure, which is defined by the claims and all equivalents thereto.

1. A surfacing film comprising a plurality of layers, in the following order:
a first clear coat layer comprising a crosslinked polyurethane that is a reaction product of a reactive mixture comprising an isocyanate and a polyol containing a styrene repeat unit and a hydroxyl-containing (meth)acrylate repeat unit; and
a bulk layer comprising a thermoplastic polyurethane; and
an adhesive layer.

2. The surfacing film of claim 1, wherein the hydroxyl-containing (meth)acrylate repeat unit is a hydroxyalkyl (meth)acrylate repeat unit.

3. The surfacing film of claim 2, wherein the polyol has a functionality of from 5 to 50.

4. The surfacing film of claim 1, wherein the polyol has a weight average molecular weight of from 250 g/mol to 30000 g/mol.

5. The surfacing film of claim 1, wherein the reactive mixture further comprises one or more of a polyester polyol, polycarbonate polyol, and polyacrylate polyol.

6. The surfacing film of claim 1, further comprising a second clear coat layer comprised of a polymer that is at least partially crosslinked.

7. The surfacing film of claim 6, wherein the second clear coat layer is comprised of a polyurethane that is at least partially crosslinked.

8. The surfacing film of claim 7, wherein the polyurethane of the second clear coat layer is a water-borne polyurethane.

9. The surfacing film of claim 1, wherein the isocyanate is an aliphatic isocyanate.

10. The surfacing film of claim 1, wherein the bulk layer comprises an aliphatic thermoplastic polyurethane.

11. The surfacing film of claim 10, wherein the bulk layer further comprises a colored thermoplastic polyurethane layer and a transparent or translucent thermoplastic polyurethane layer disposed thereon.

12. The surfacing film of claim 11, wherein the colored thermoplastic polyurethane layer comprises a colored sublayer that is translucent and a base sublayer that is substantially opaque.

13. A process of making a surfacing film comprising:
disposing a first curable polyurethane clear coat composition on a first release liner, the first curable polyurethane clear coat composition comprising a copolymer of styrene and a hydroxyl-containing (meth)acrylate;
only partially curing the first curable polyurethane clear coat composition to provide a first clear coat layer;
disposing a second curable polyurethane clear coat composition onto the first clear coat layer;
at least partially curing the second curable polyurethane clear coat composition to provide a second clear coat layer on the first clear coat layer;
disposing a thermoplastic polyurethane layer onto the second clear coat layer; and
disposing an adhesive layer onto the thermoplastic polyurethane layer.

14. The process of claim 13, wherein the only partially cured first curable polyurethane clear coat composition is from 30% to 70% cured.

15. The process of claim 13, wherein the first curable polyurethane clear coat composition comprises:
an isocyanate; and
a polyol containing a styrene repeat unit and a hydroxyl-containing (meth)acrylate repeat unit.

16. The process of claim 13, wherein disposing the thermoplastic polyurethane layer onto the second clear coat layer comprises extruding or thermally laminating the thermoplastic polyurethane layer onto the second clear coat layer.

17. The process of claim 13, wherein the thermoplastic polyurethane layer is laminated onto the second clear coat layer, and disposing the adhesive layer onto the thermoplastic polyurethane layer occurs prior to disposing the thermoplastic polyurethane layer onto the second clear coat layer.

18. The process of claim 13, wherein the adhesive layer is coextruded or thermally laminated onto the thermoplastic polyurethane layer, and the adhesive layer is disposed onto a release liner prior to thermally laminating the adhesive layer onto the thermoplastic polyurethane layer.

19. The process of claim 13, wherein the thermoplastic polyurethane layer comprises a colored thermoplastic polyurethane layer and a transparent thermoplastic polyurethane layer disposed thereon.
